(19) United States
(12) Patent Application Publication
(10) Pub. No.: US 2005/0081190 A1
(43) Pub. Date: Apr. 14, 2005

(54) Autonomic memory leak detection and remediation

(75) Inventors: Michel Betancourt, Morrisville, NC (US); Dipak M. Patel, Morrisville, NC (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/675,181

(22) Filed: Sep. 30, 2003

(51) Int. Cl. G06F 9/44

(52) U.S. Cl. 717/124; 711/159

(57) ABSTRACT

A method, system and apparatus for detecting and remediating a memory leak. In the method of the invention, an aging value can be established for an object instance created in memory and resetting the aging value when the object instance is referenced by an executing process. By comparison, the aging value can be incremented during a garbage collection pass when the object instance had not been referenced by an executing process since a previous garbage collection pass. Importantly, when the aging value exceeds a threshold value, the object instance can be processed as a loiterer. The processing step itself can include clearing at least one cache in memory, and reporting said object instance as a loiterer in a log file. Yet, the processing step can be avoided where the object instance belongs to a specified exempt class.

### BACKGROUND OF THE INVENTION

1. Statement of the Technical Field

The present invention relates to the field of memory leakage and more particularly to garbage collection to remediate memory leakage.

2. Description of the Related Art

Memory leakage has confounded software developers for decades resulting in the sometimes global distribution of bug-ridden, crash-prone software applications. Particularly in respect to those programming languages which permitted the manual allocation of memory, but also required the manual de-allocation of allocated memory, memory leakage has proven to be the principal run-time bug most addressed during the software development cycle. So prevalent a problem has memory leakage become, entire software development tools have been developed and marketed solely to address the memory leakage problem.

Memory leakage, broadly defined, is the gradual loss of allocable memory due to the failure to de-allocate previously allocated, but no longer utilized memory. Typically, memory can be reserved for data having a brief lifespan. Once the lifespan has completed, the reserved memory ought to be returned to the pool of allocable memory so that the reserved memory can be used at a subsequent time as necessary. Importantly, where memory leakage persists without remediation, ultimately not enough memory will remain to accommodate the needs of other processes.

Recognizing the importance of addressing the memory leakage problem, computer programming language theorists have developed the notion of garbage collection. Garbage collection refers to the automated analysis of allocated memory to identify regions of allocated memory containing data which no longer are required for the operation of associated processes. In the context of object oriented programming languages such as the Java™ programming language, when objects residing in memory are no longer accessible within a corresponding application, the memory allocated to the “dead” object can be returned to the pool of allocable memory.

One well known garbage collection algorithm, the “Mark and Sweep” garbage collection algorithm, has been deployed in recent releases of the Java Virtual Machine (JVM). FIG. 1 is a flow chart illustrating the conventional and well known Mark and Sweep garbage collection process. Beginning in block 110 leading into decision block 120, it can be determined whether a memory allocation failure has arisen responsive to a request to allocate a block of memory (typically the heap). If so, in block 130 a first object in the heap can be retrieved for analysis. If in decision block 140 it is determined that the object is reachable from the root meaning that the object has been configured for contemporary access within an active aspect of an executing process, then in block 150 the object can be marked as alive.

Subsequently in block 160, if more objects remain to be analyzed in memory, in decision block 170 the next object in the heap can be retrieved for analysis. Upon retrieval, the process of blocks 130 through 170 can repeat and the process can continue for all objects in the heap. In decision block 160, where no objects in the heap remain to be analyzed, in block 180, all unmarked objects in the heap can be removed so that the underlying memory can be returned to the pool of memory which can be allocated responsive to new allocation requests. Finally, in block 190, the process can end.

One skilled in the art will recognize that the Mark and Sweep algorithm of FIG. 1 relies upon the notion that objects which reside in memory, but which can no longer be accessed by an active aspect of an executing process, are orphaned blocks of memory which ought to be de-allocated. Such reasoning, however, ignores the possibility that such a circumstance can be the result of an intentional programming construct. Moreover, the Mark and Sweep process does not account for loitering objects—those objects which are referenced by other live objects in the heap, but which have no future use. In many cases, however, loitering objects can form the basis of a memory leak.

### SUMMARY OF THE INVENTION

The present invention addresses the deficiencies of the art in respect to memory leak detection and remediation and provides a novel and non-obvious method, system and apparatus for autonomic memory leak detection and remediation. In a preferred aspect of the present invention, an autonomic memory leak detection and remediation system can include an autonomic garbage collector coupled to memory configured to store object instances which can be accessed by executing processes and which can be referenced by other object instances in the memory. The system further can include a tracing policy coupled to the autonomic garbage collector. The tracing policy can specify an aging threshold for a number of garbage collection passes during which an object instance in the memory is considered a loiterer when the object instance had not been accessed by one of the executing processes.

Notably, the memory can be a heap managed through a virtual machine. Moreover, the autonomic garbage collector can include a mark and sweep garbage collector modified both to manage aging values associated with object instances in the memory and also to compare the aging values to the aging threshold to identify loiterers. Finally, the tracing policy can include both a specification for at least one action to be undertaken upon detecting a loiterer, and also a listing of exempt classes based upon which object instances are exempted from being labeled loiterers.

A method for detecting and remediating a memory leak can include establishing an aging value for an object instance created in memory and resetting the aging value when the object instance is referenced by an executing process. By comparison, the aging value can be incremented during a garbage collection pass when the object instance had not been referenced by an executing process since a previous garbage collection pass. Importantly, when the aging value exceeds a threshold value, the object instance can be processed as a loiterer. In a preferred aspect of the invention, the establishing step can include locating equivalent object instances in the memory; and, processing the equivalent object instances in the memory as loiterers. Yet, the processing step can be avoided where the object instance belongs to a specified exempt class.

The processing step itself can include clearing at least one cache in memory, and reporting said object instance as a loiterer in a log file. In particular, in the former case, as memory usage approaches its maximum limit, objects in the cache or caches can be de-referenced in order to provide immediately relief. To that end, a priority list of caches and object pools can be established, particularly in the case of a virtual machine. More particularly, the priority list can be established in the form of a properties file. As heap usage approaches its maximum limit, such as when memory allocation failures become prevalent, objects in cache can be selectively de-referenced based upon the list provided in the properties file.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a flow chart illustrating the Mark and Sweep garbage collection process known in the art;

FIG. 2 is a block diagram illustrating an autonomic garbage collection system configured in accordance with a preferred aspect of the inventive arrangements; and,

FIGS. 3A through 3D, taken together, are a flow chart illustrating an autonomic garbage collection process for use in the system of FIG. 2.

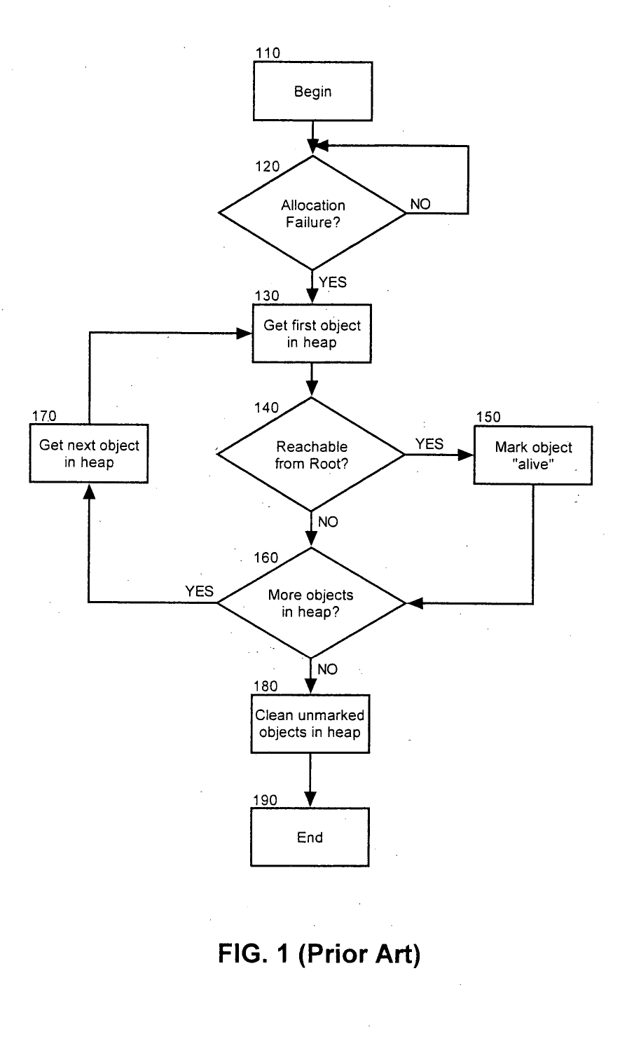

### DETAILED DESCRIPTION OF THE PREFERRED EMBODIMENTS

The present invention is an autonomic memory leak detection and remediation system, method and apparatus. In accordance with the present invention, loiterers in memory can be identify based upon objects in memory which are referenced by other live objects in memory, but which have no other use. Objects can be exempted from the remediation process based upon a pre-specified configuration. Moreover, once detected, loiterers can be acted upon variably depending upon the terms of the pre-specified configuration. Actions can range from reporting the loiterer in a heap dump to purging the loiterer through garbage collection.

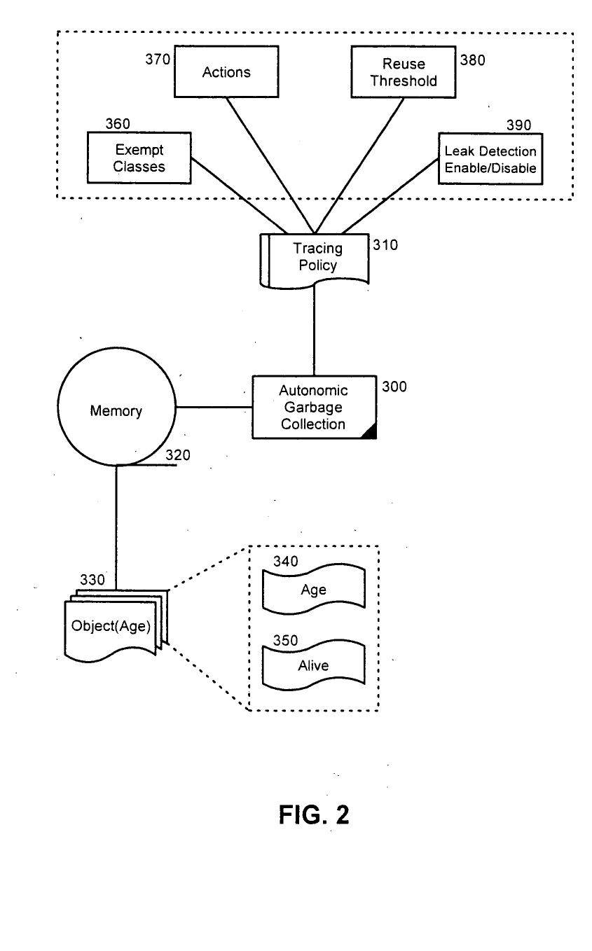

FIG. 2 is a block diagram illustrating an autonomic garbage collection system configured in accordance with a preferred aspect of the inventive arrangements. The system can include at its focal point, an autonomic garbage collection process 300 programmed according to the present invention as described herein. The autonomic garbage collection process 300 can be coupled both to a tracing policy 310 and memory 320, for instance the heap of a virtual machine. The memory 320 can be configured to include a multiplicity of objects 330. Each object can be associated with an aging value 340 and an alive value 350. The aging value 340 can specify how many passes of the autonomic garbage collection process 300 have occurred since the object 330 last had been referenced. The alive value 350, by comparison, can specify whether the object 330 is reference by another object in memory 320.

The tracing policy 310 can specify a number of variable elements relied upon by the autonomic garbage collection process 300. For instance, the tracing policy 310 can include an indication 390 of whether the leak detection and remediation process of the present invention has been enabled, or disabled. For instance, to the extent that the process of the present invention can generate latencies in the execution of an application within the virtual machine, it can be advantageous to disable the autonomic garbage collection process where execution speed is of a concern. The tracing policy also can specify a re-use threshold 380 beyond which an object 330 has aged can be considered a loiterer.

Importantly, upon detecting a loiterer, an object can face a range of remedial actions 370 specified within the tracing policy 310. The actions 370 can range from reporting the loiterer in a heap dump, to forcing the loiterer through purging the object from the heap. Yet, not all loiterers need face a remedial action, even when the objects has aged beyond the reuse threshold 380. In particular, objects belonging to a class specified among a set of exempt classes 360 in the tracing policy can be exempted from remedial action. In this way, where in the course of software development it is expected that several instances of the same class are to be created in memory, loitering will not be a presupposition.

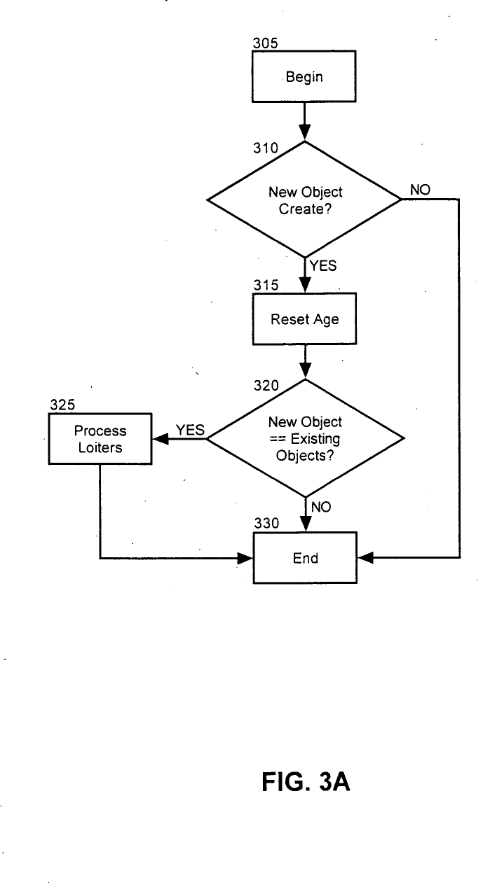

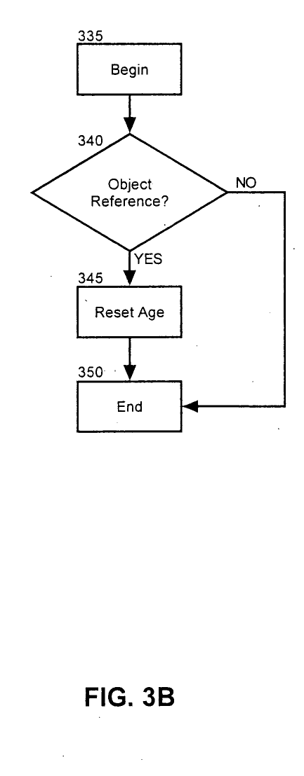

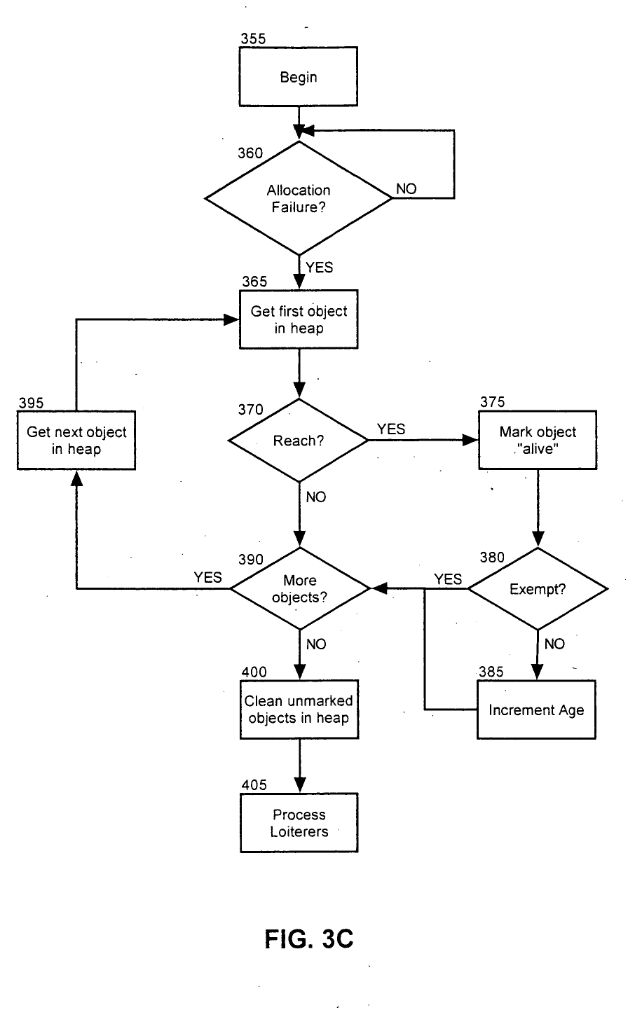

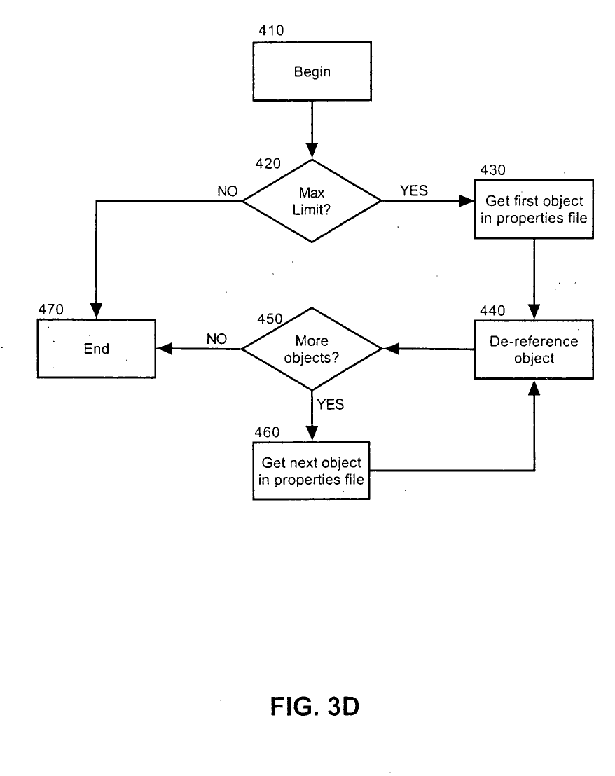

In further illustration of the operation of the garbage collection process 300 of FIG. 2, FIGS. 3A through 3D, taken together, depict an autonomic garbage collection process for use in the system of FIG. 2. Beginning first with FIG. 3A in block 305 leading into decision block 310, when a new object instance has been created in memory, an associated aging value can be reset in block 315. Additionally, in decision block 320 it can be determined whether other object instances already existing within memory are equivalent to the new object instance. If so, in block 325 the existing object instances can be labeled as potential loiterers and processed as such in accordance with the recommended actions of the tracing policy before the process can end in block 330.

Turning now to FIG. 3B, in block 335 leading into decision block 340, when an object instance disposed in memory has been referenced by an active process, the aging value associated with the object instance can be reset in block 345 before the process can end in block 350. Importantly, during the core garbage collection process illustrated in FIG. 3C, the aging value of each object instance in memory can be queried to identify those object instances which have not been referenced by an active process for many operable cycles of the garbage collection process. Those identifiable objects can be considered loiterers and processed accordingly.

With more particular reference to FIG. 3C, beginning in block 355 and leading through decision block 360, upon detecting a memory allocation failure, in block 365 the first object instance in the heap can be analyzed. Specifically, in decision block 370 if the object instance can be “reached” from the root indicating that another object instance in memory maintains a reference to the object instance, in block 375 the object instance can be marked as “alive”. Additionally, in decision block 380 it can be determined if the object instance is a member of an exempt class by virtue of which the object cannot be processed as a loiterer. If not, the aging value associated with the object can be incremented.

If in decision block 390 additional object instances in memory remain to be analyzed, in block 395 the next object instance in the heap can be retrieved and the process can repeat in blocks 365 through 395. Once no more object instances remain to be analyzed in the heap, in block 400 all unmarked objects can be purged from the heap returning the corresponding memory to an allocable state. Additionally, in block 405 the object instances who are potential loiterers can be processed.

More particularly, as shown in FIG. 3D, beginning in block 410 and leading into decision block 420, it first can be determined whether memory has reached its maximum limitation such as the case where a memory allocation failure has occurred. If not, the process can end in block 470. Otherwise, in block 430 the first object in the properties file can be selected and in block 440 the selected object can be de-referenced. In this regard, it is to be recognized that where the selected object is an object cache, the information contained therein is redundant in nature and its de-referencing will have negligible impact in consequence. Subsequently, in decision block 450, if additional objects remain in the properties file, in block 460 the next object in the properties file can be retrieved and in block 440, once again the selected object can be de-referenced. The process can continue until no more objects remain to be selected in the properties file. Subsequently, the process can end in block 470.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. An autonomic memory leak detection and remediation system comprising:
an autonomic garbage collector coupled to memory configured to store object instances which can be accessed by executing processes and which can be referenced by other object instances in said memory;
a tracing policy coupled to said autonomic garbage collector, said tracing policy specifying an aging threshold for a number of garbage collection passes during which an object instance in said memory is considered a loiterer when said object instance had not been accessed by one of said executing processes.

2. The system of claim 1, wherein said memory is a heap managed through a virtual machine.

3. The system of claim 1, wherein said autonomic garbage collector comprises a mark and sweep garbage collector modified both to manage aging values associated with object instances in said memory and also to compare said aging values to said aging threshold to identify loiterers.

4. The system of claim 1, wherein said tracing policy further comprises a specification for at least one action to be undertaken upon detecting a loiterer.

5. The system of claim 1, wherein said tracing policy further comprises a listing of exempt classes based upon which object instances are exempted from being labeled loiterers.

6. A method for detecting and remediating a memory leak, the method comprising the steps of:
establishing an aging value for an object instance created in memory;
resetting said aging value when said object instance is referenced by an executing process;
incrementing said aging value during a garbage collection pass when said object instance had not been referenced by an executing process since a previous garbage collection pass; and,
when said aging value exceeds a threshold value, processing said object instance as a loiterer.

7. The method of claim 6, wherein said establishing step further comprises the steps of:
locating equivalent object instances in said memory; and,
processing said equivalent object instances in said memory as loiterers.

8. The method of claim 6, wherein said processing step comprises at least one of clearing at least one cache in memory, and reporting said object instance as a loiterer in a log file.

9. The method of claim 6, further comprising the step of foregoing said processing step where said object instance belongs to a specified exempt class.

10. An autonomic memory leak detection and remediation method comprising the steps of:
modifying a mark and sweep garbage collection process to manage aging values associated with object instances created in memory; and,
processing as loiterers selected ones of said object instances having aging values which exceed a predetermined threshold.

11. The method of claim 10, wherein said processing step comprises the step of processing as loiterers selected ones of said object instances not belonging to an exempt class where said selected ones of said object instances have aging values which exceed a predetermined threshold.

12. The method of claim 10, wherein said processing step comprises clearing at least one cache in memory, and reporting said object instance as a loiterer in a log file.

13. A machine readable storage having stored thereon a computer program for detecting and remediating a memory leak, the computer program comprising a routine set of instructions for causing the machine to perform the steps of:
establishing an aging value for an object instance created in memory;
resetting said aging value when said object instance is referenced by an executing process;
incrementing said aging value during a garbage collection pass when said object instance had not been referenced by an executing process since a previous garbage collection pass; and,
when said aging value exceeds a threshold value, processing said object instance as a loiterer.

14. The machine readable storage of claim 13, wherein said establishing step further comprises the steps of:
locating equivalent object instances in said memory; and,
processing said equivalent object instances in said memory as loiterers.

15. The machine readable storage of claim 13, wherein said processing step comprises clearing at least one cache in memory, and reporting said object instance as a loiterer in a log file.

16. The machine readable storage of claim 13, further comprising the step of foregoing said processing step where said object instance belongs to a specified exempt class.
